(19) United States
(12) Patent Application Publication
(10) Pub. No.: US 2009/0251908 A1
(43) Pub. Date: Oct. 8, 2009

(54) INTEGRATED HEADLIGHT ASSEMBLY FOR TACTICAL VEHICLES

(75) Inventors: Michael A. Czuhanich, Vestal, NY (US); John Ford, Binghampton, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 12/098,528

(22) Filed: Apr. 7, 2008

(51) Int. Cl. B60Q 1/04; B60Q 1/26

(52) U.S. Cl. 362/485; 362/507; 362/540

(57) ABSTRACT

An integrated front lighting unit for a tactical vehicle, which includes a housing, multiple lights and a single connector for connection to a vehicle electrical system. All the parts are located in or on the housing which may include a front, a top, a bottom, two sides, a back and mounting tabs or another mounting arrangement. There is wiring for each light in the unit having a cable and all cables are attached to the single connector. The multiple lights in the unit may include a blackout driving light, a blackout turn signal, a headlight, a turn signal and a side marker truck light. The lights may use LEDs as light sources.

### FIELD OF THE INVENTION

This invention relates generally to the vehicle art, and, more particularly to an integrated headlight assembly for tactical vehicles.

### BACKGROUND OF THE INVENTION

U.S. Pat. No. 3,735,116 provides a lamp base fastened to a vehicle body surface which is to seal a protective cavity into which conductors extend.

U.S. Pat. No. 3,831,018 provides a vehicle lamp having a side light emitting lens

U.S. Pat. No. 4,163,275 provides a converter for a vehicle light for converting a side marker light to a combination side marker and clearance light.

U.S. Pat. No. 4,412,274 provides a support housing for a vehicle headlamp

U.S. Pat. No. 4,575,782 provides a collision avoidance light mounted at the rear window of an automobile.

U.S. Pat. No. 4,797,792 provides a forward light housing assembly which incorporates both headlights and a turn signal into a package which is attached to the leading edge of the fender and incorporated into the fender.

U.S. Pat. No. 5,025,350 provides a clearance lamp assembly.

U.S. Pat. No. 5,584,559 provides a headlamp for a motor vehicle using a discharge bulb as a light source which provides a degree of safety in removing an actuator circuit.

U.S. Pat. No. 6,008,584 provides a headlamp for a vehicle having a discharge lamp and which can cut off a lighting circuit whenever work is performed in the lamp housing.

United Kingdom patent, GB 2119 913 A, discloses vehicle rear lamp assembly clusters.

Japanese patent abstract 58093639 A discloses a fixing structure of the front cover of a retractable head lamp which is removably supported on the body of an automobile.

### SUMMARY OF THE PRESENT INVENTION

Traditionally, forward lighting for tactical vehicles is accomplished by selecting individual components (i.e., headlight, blackout headlight, directionals, blackout directions, and side markers) and installing them on the vehicle. Each component requires a specific mounting space and method. This method tends to lay claim to a large amount of space on the vehicle and can be difficult to accomplish. Additionally, each component requires a dedicated mounting bracket or bucket. Each of these brackets or buckets add to the overall gross vehicle weight (GVW). With regards to certain prior art vehicles, the space available is extremely limited, making the use of individual components even more difficult. The present invention eliminates the need for individual components. It is designed to be easily used on present types of vehicle platforms. It also correctly connects each individual component to its wiring harness. Each of the individual components has a number of individual wires and connectors that are prone to incorrect connection. The assembly has just one Mil-Spec connector that is pre-wired and tested upon assembly manufacture. Installation on the vehicle involves just a few fasteners and one connection to the vehicle lighting wire harness, which would be tested at its manufacture, thereby eliminating the possibility of mis-wiring the unit.

The present invention combines the Federal Motor Vehicle Safety Standards (FMVSS) for lights with military standard (Mil-Standard) compliant blackout lighting in one common assembly. Physical mounting of the assembly is now accomplished without the use of custom brackets or buckets. The assembly is easily installed, reducing vehicle manufacturing labor time, and can easily be field replaced in minutes if the need arises. Standard FMVSS required lighting and Military required tactical (blackout) lighting are integrated into one common assembly that easily attaches to the vehicle's wire harness. In one embodiment, the design incorporates a single 4″×6″ single headlight with high- and low-beam capability, an LED park/directional light, and an LD side-marker light to meet FMVSS Standards. It also incorporates a Military-Standard compliant blackout headlight (which can be on the driver's side only) with blackout directionals within the same enclosure. The FMVSS headlight is mechanically adjustable for aiming purposes. All of the lights are then wired to a common Mil-Spec connector on the inner surface of the enclosure. The overall assembly requires a substantially smaller area to mount to the vehicle. It is designed to be lighter, reducing GVW, yet resistant to normal physical damage.

The present invention integrates required tactical vehicle forward lighting into a common enclosure, reducing the need for space claim and special bracket call-out. It eliminates interference with vehicle armor capabilities on the light weight prime mover (LWPM). By combining all required lighting into a single assembly, space on the vehicle is freed up for the implementation of other components or systems. On the LWPM specifically, it allows for a better fit of front glad-hands and the vehicle's winch.

By eliminating the use of individual components and brackets, there is a significant reduction in the labor time required to fit forward lighting to the vehicle. The use of a common connector eliminates the possibility of incorrect wiring and the trouble shooting time required to correct. Additionally, field repair time for damaged units is expedited. The assembly is designed to be integrated into the designs of other tactical vehicle platforms, such as the future tactical truck system (FTTS) or joint light tactical vehicle (JLTV) rather easily.

The present invention together with the above and other advantages may best be understood from the following detailed description of the embodiments of the invention illustrated in the drawings, wherein:

### BRIEF DESCRIPTION OF THE DRAWINGS

FIG. 1 is an isometric view of the lighting assembly of the present invention intended for the left side of a vehicle.

FIG. 2 is a front elevational view of the lighting assembly.

FIG. 3 is a view taken generally along the plane defined by reference line 3-3 of FIG. 2.

FIG. 4 is a side elevational view from the right side of the lighting assembly shown in FIG. 2.

FIG. 5 is a side elevational view of the lighting assembly shown in FIG. 2 from the left side.

FIG. 6 is an isometric view of the lighting assembly of the present invention intended for the right side of a vehicle.

FIG. 7 is an isometric diagrammatic view of a tactical vehicle having left and right side integrated lights attached.

### DETAILED DESCRIPTION OF PREFERRED EMBODIMENTS

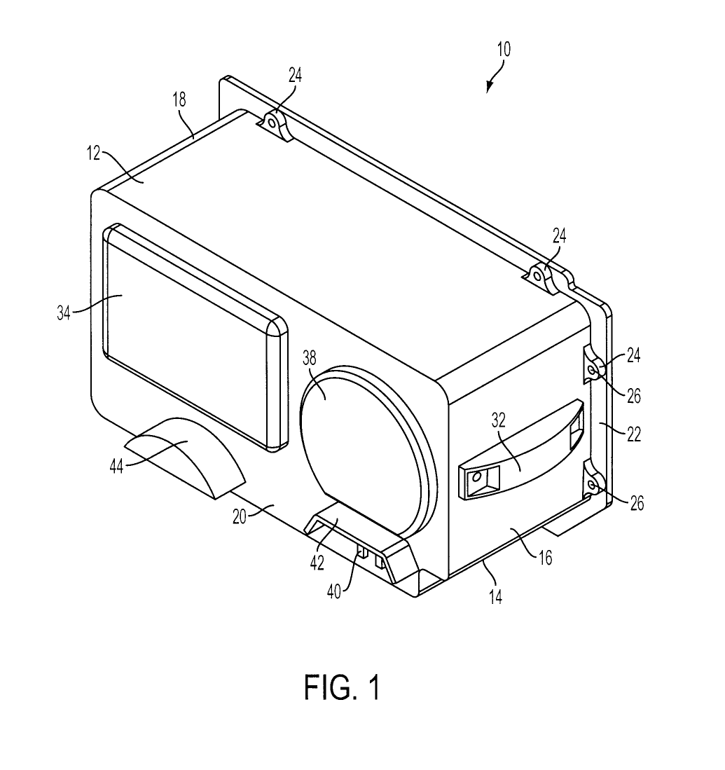

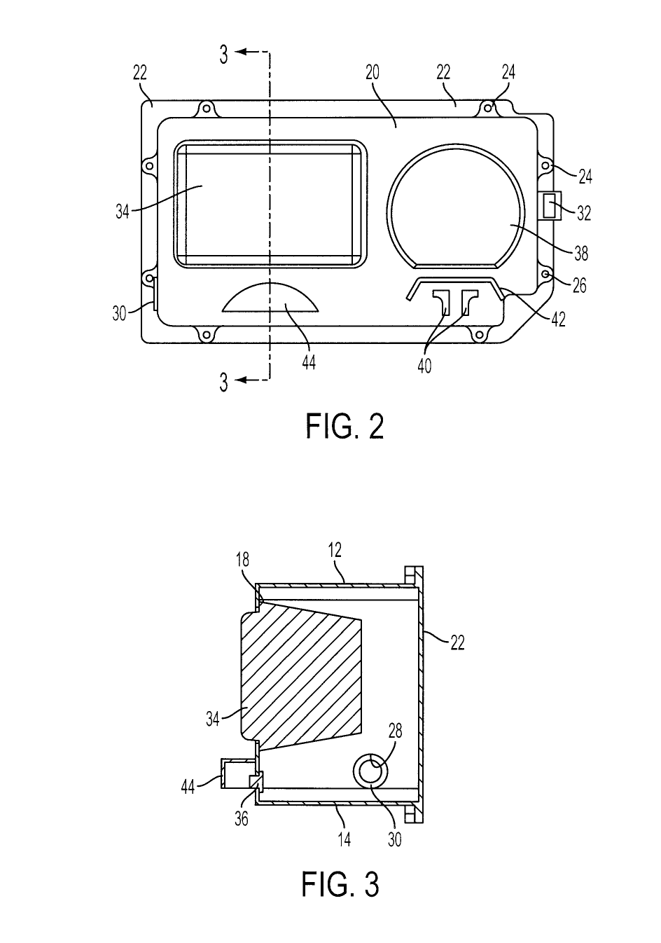

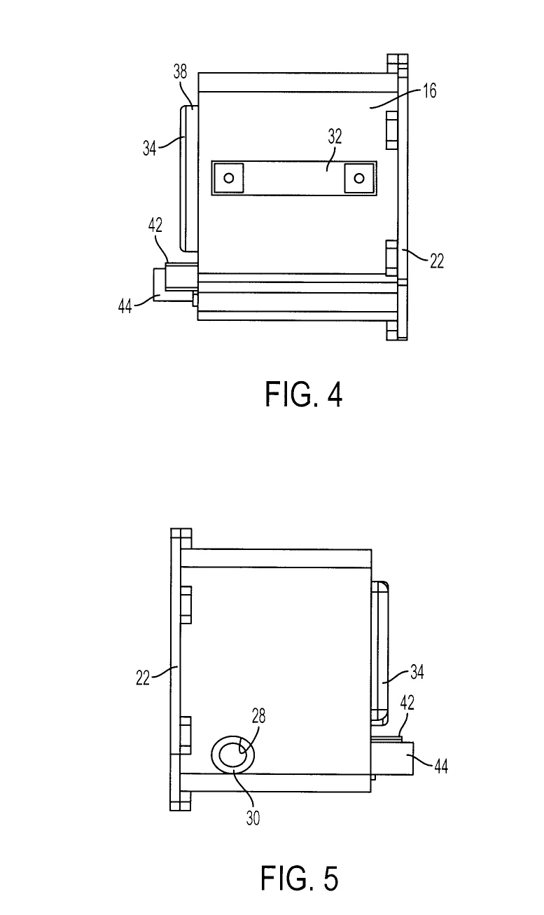

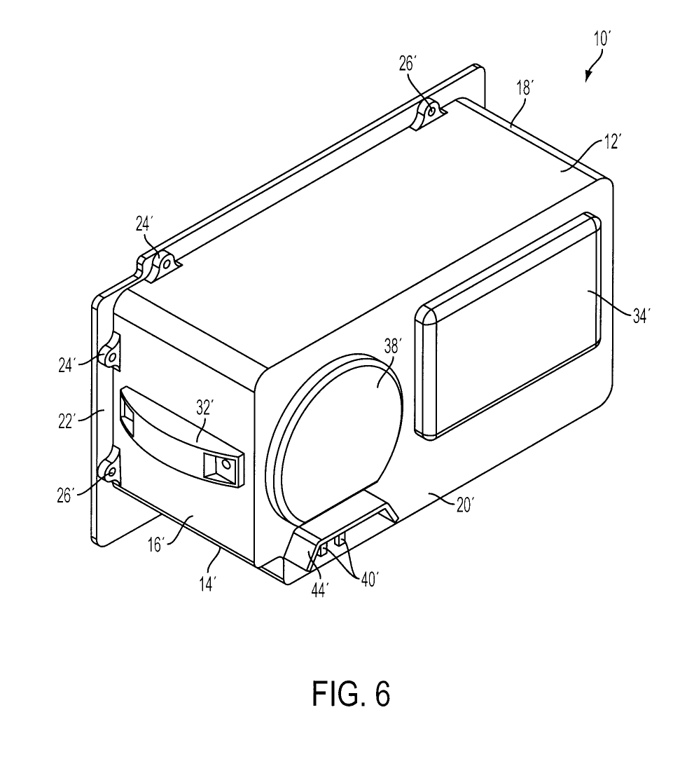

The present invention provides a tactical military vehicle having an integrated light assembly, one for each side of the front of the vehicle. The integrated light assembly for the left side is shown in FIG. 1 and the integrated light assembly for the right side is shown in FIG. 6. This includes a housing 10 which has a top 12, bottom 14, two sides 16 and 18 and a front 20, and a rear cover 22 to seal the back of the assembly. The rear cover is a separate panel is used to close the back after assembly. The housing has tabs 24 on the top, bottom and sides for mounting the lighting assembly to a tactical vehicle. The tabs have openings 26 to allow attachment to the vehicle using bolts or the like (not shown). Side 18 which faces the engine compartment and interior has an opening 28 with a rubber grommet 30 in it through which the unified wiring cable (not shown) passes to be connected into the electrical system.

The front 20 has an opening for a headlight 34 below which is a blackout driving light 36. Side 16 has a side marker truck light 32. On the other side from the headlight 34 is a turn signal arrangement 38 below which is a blackout turn signal assembly 40. Above and around the blackout driving light 36 is a light shield 42 and above and around the blackout turn signal 40 is a light shield 44.

As can be seen from FIG. 6, the right hand light assembly does not have a blackout driving light which is only provided on the left hand assembly where the driver is located. The parts of the right hand light assembly are numbered the same as the left hand assembly having primes added to the reference numerals.

Thus, the left hand integrated light assembly includes a housing 10′ which has a top 12′, bottom 14′, two sides 16′ and 18′ and a front 20′, and a rear cover 22′ to seal the back of the assembly. The rear cover is a separate panel is used to close the back after assembly. The housing has tabs 24′ on the top, bottom and sides for mounting the lighting assembly to a tactical vehicle. The tabs have openings 26′ to allow attachment to the vehicle using bolts or the like (not shown). Side 18′ which faces the engine compartment and interior has an opening (not shown) with a rubber grommet (not shown) in it through which the unified wiring cable (not shown) passes to be connected into the electrical system.

The front 20′ has an opening for a headlight 34′, but does not have a blackout driving light which is only provided on the driver's side. Side 16′ has a side marker truck light 32′. On the other side from the headlight 34′ is a turn signal arrangement 38′ below which is a blackout turn signal assembly 40′. Above and around the blackout turn signal 40′ is a light shield 44′.

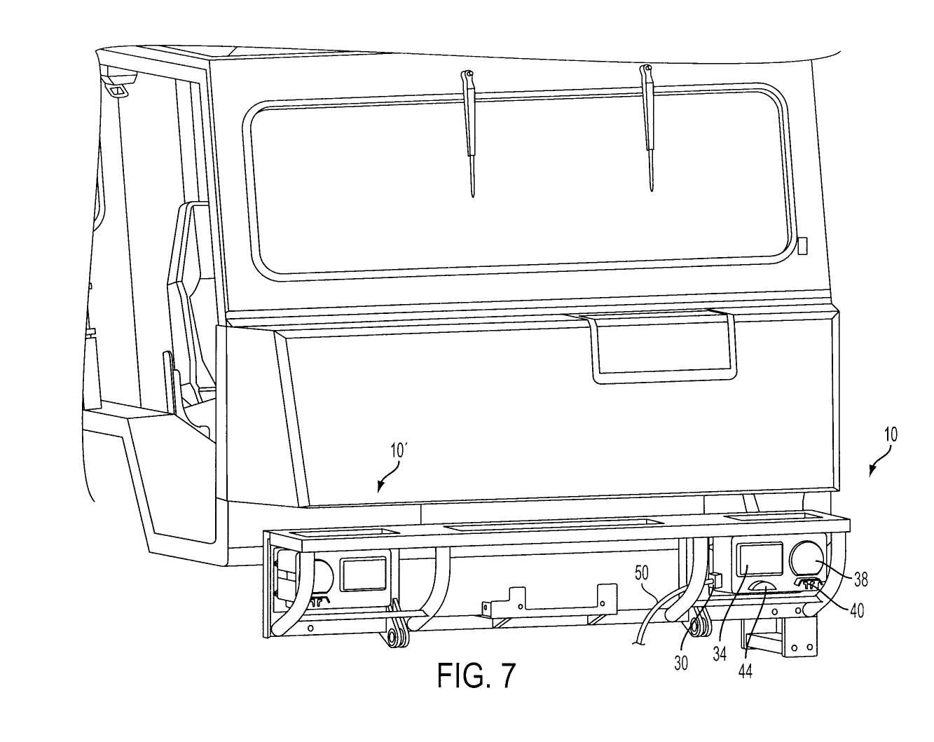

FIG. 7 shows a tactical vehicle with left 10 and right 10′ integrated headlight assemblies attached. This figure also shows the integrated electrical cable 50 extending out of the grommet 30 for attachment into the electrical system.

A lighting upgrade to Military lighting is desirable for the Lightweight Prime Mover program. There is limited space available to accomplish this task with conventional, discrete lighting components. Additionally, the required number of electrical connections is prone to mis-wiring, leading to incorrect operation and requiring troubleshooting.

Traditionally, forward lighting for Tactical Vehicles is accomplished by selecting individual components (i.e., headlight, blackout headlight, directionals, blackout directions, and side markers) and installing them on the vehicle. Each component requires a specific mounting space and method. This arrangement requires a large amount of space on the vehicle and can be difficult to accomplish. Additionally, each component requires a dedicated mounting bracket or bucket. Each of these brackets or buckets add to the overall gross vehicle weight (GVW). With regards to a Light Weight Prime Mover (LWPM), the space available is extremely limited, making the use of individual components even more difficult. The present invention eliminates the need for individual components. It assures the correct connection of each individual component to its wiring harness. Each of the individual components in the prior art arrangements has a number of individual wires and connectors that are prone to incorrect connection. The present invention has just one Mil-Spec connector that is pre-wired and tested upon assembly manufacture. Installation on the vehicle involves just a few fasteners and one connection to the vehicle lighting wire harness, which would be tested at its manufacture, thereby eliminating the possibility of mis-wiring the unit.

The present invention combines standard vehicle light (FMVSS) with Mil-Standard compliant blackout lighting in one common assembly. Physical mounting of the assembly can be accomplished without the use of custom brackets or buckets. The assembly is easily installed, reducing vehicle manufacturing labor time, and can easily be field replaced in minutes if the need arises. Standard FMVSS required lighting and Military required tactical (blackout) lighting are integrated into one common assembly that easily attaches to the vehicle's wire harness. One embodiment of the present invention incorporates a single 4″×6″ single headlight with high- and low-beam capability, an LED park/directional light, and an LD side-marker light to meet FMVSS Standards. It also incorporates a Military-Standard compliant blackout headlight (on the driver's side only) with blackout directionals within the same enclosure. The FMVSS headlight is mechanically adjustable for aiming purposes. All of the lights are then wired to a common Mil-Spec connector on the inner surface of the enclosure. The overall assembly requires a substantially smaller area to mount to the vehicle. It is designed to be lighter, reducing GVW, yet resistant to normal physical damage.

This arrangement integrates required tactical vehicle forward lighting into a common enclosure, reducing the need for space claim and special bracket call-out. It eliminates interference with vehicle armor capabilities on the LWPM. By combining all required lighting into a single assembly, space on the vehicle is freed up for the implementation of other components or systems. On the LWPM, it allows for a better fit of front glad-hands and the vehicle's winch. By eliminating the use of individual components and brackets, there has been a significant reduction in the labor time required to fit forward lighting to the vehicle. The use of a common connector eliminates the possibility of incorrect wiring and the trouble shooting time required to correct. Additionally, field repair time for damaged units is expedited. The assembly is designed to be integrated into the designs of other tactical vehicle platforms (line the FTTS or JLTV) rather easily.

The integrated lighting assembly of the present invention is thus constructed and arranged to be quickly and readily attached and detached from a vehicle.

It is to be understood that the above-described embodiments are simply illustrative of the principles of the invention. Various and other modifications and changes may be made by those skilled in the art which will embody the principles of the invention and fall within the spirit and scope thereof.

1. In a tactical vehicle having a chassis, body, engine, tires, electrical system and lighting, the improvement comprising an integrated front lighting unit which includes multiple lights and a single connector to the vehicle electrical system, at least one of the lights being a blackout light.

2. The improvement of claim 1 wherein the blackout light is a driving light.

3. The improvement of claim 2 wherein the blackout light is a turn signal.

4. The improvement of claim 1 wherein the multiple lights include a driving blackout light and a turn signal blackout light.

5. The improvement of claim 4 further comprising wiring for each light in the unit having a cable and all cables being attached to said single connector.

6. The improvement of claim 5 wherein the multiple lights include a side marker truck light.

7. The improvement of claim 6 wherein the multiple lights includes a headlight.

8. The improvement of claim 7 wherein the multiple lights include a turn signal.

9. The improvement of claim 8 wherein the integrated front lighting unit includes a housing into and on which all the parts are located.

10. The improvement of claim 9 wherein the housing includes a front, a top, a bottom, two sides, a back and mounting tabs.

11. An integrated front lighting unit for a tactical vehicle, comprising a housing, multiple lights and a single connector for connection to a vehicle electrical system, at least one of the lights being a blackout light.

12. The integrated front lighting unit of claim 11 wherein the multiple lights include a driving blackout light.

13. The integrated front lighting unit of claim 11 wherein the multiple lights in the unit include a blackout turn signal.

14. The integrated front lighting unit of claim 13 wherein the multiple lights in the unit include a headlight and a turn signal.

15. The integrated front lighting unit of claim 14 wherein unit includes a housing into and on which all the parts are located.

16. The integrated front lighting unit of claim 15 wherein the housing includes a front, a top, a bottom, two sides, a back and mounting tabs.

17. The integrated front lighting unit of claim 16 further comprising wiring for each light in the unit having a cable and all cables being attached to said single connector.

18. The integrated front lighting unit of claim 16 wherein the multiple lights in the unit include a side marker truck light.

19. The integrated front lighting unit of claim 18 further comprising LEDs as the light sources for each light.

20. The integrated front lighting unit of claim 19 wherein the unit is constructed and arranged to be quickly and readily attached and detached from a vehicle.
